(19) United States
(12) Patent Application Publication
(10) Pub. No.: US 2020/0391852 A1
(43) Pub. Date: Dec. 17, 2020

(54) WINGLET WITH INJECTED FLOW

(71) Applicant: United States of America as Represented by the Administrator of NASA, Washington, DC (US)

(72) Inventor: Jeffrey Shawn LOGAN, Los Altos Hills, CA (US)

(21) Appl. No.: 16/900,990

(22) Filed: Jun. 14, 2020

Related U.S. Application Data
(60) Provisional application No. 62/861,994, filed on Jun. 14, 2019.

(51) Int. Cl. B64C 21/04; B64C 5/08

(52) U.S. Cl. CPC B64C 21/04; B64C 5/08

(57) ABSTRACT

A wing having a winglet that provides a trailing-edge injection effect through a set of air outlets along the trailing-edge of the wing. The air flow is passively supplied by inlets formed at the leading edge of the wing that ingest air during flight, and directed to the outlets by ducts. The air flow may also be actively supplied by tapping into the engine bleed lines already in the wing of the aircraft. The trailing-edge injection effect reduces vortex drag, resulting in fuel savings in the operation of the aircraft.

### ORIGIN OF THE INVENTION

The invention described herein was made by an employee of the United States Government and may be manufactured and used by or for the Government of the United States of America for governmental purposes without the payment of any royalties thereon or therefor.

### FIELD OF THE INVENTION

The present embodiments relate to aircraft wing-tip devices, more particularly, to wing-tip devices with the addition of pores for reducing vortex drag.

### BACKGROUND OF THE INVENTION

Fuel efficiency is a key driver in aircraft design, allowing some combination of lower fuel costs and/or higher payloads. Wing-tip devices, such as winglets, which are attachments to the tip of aircraft wings, are commonly used to minimize wing-tip vortices, reducing aircraft drag by 2-3 drag counts (e.g., allowing for 400-600 pounds of additional payload at the same fuel cost). While lowering drag overall, some additional drag is induced at the root of a winglet.

It would be desired to have winglets modified to reduce the additional drag induced at the root of a winglet.

### BRIEF SUMMARY OF EMBODIMENTS OF THE INVENTION

According to some embodiments, a winglet is made porous with one or more leading edge air or jet inlets, which then direct this air to one or more lower air or jet outlets. By providing a passive wing tip blown effect, the desire would be to reduce vortex drag, and to provide additional lift. In addition, the one or more lower air or jet outlets could also have an influence on reducing pressure-induced drag and friction drag. Some embodiments of the invention use passively ducted air, versus taking bleed air from one or more engines. Some embodiments include trailing-edge injection at a plurality of outlets long the trailing edge of the winglet. Such the injected flow in the trailing edge direction may be sourced from engine bleed air lines in the wing (i.e., tied into anti-ice system). Such trailing-edge injection may be used in addition to the porous winglet which has leading edge flow ingestion and ducted flow in the trailing edge direction. In some embodiments, the winglet generates enough ducted lift to offset the winglet weight. In some embodiments, the winglet will have one or more openings on the leading edge, and internal duct routing to the base for a blown tip effect, or to the trailing edge for a trailing edge injection effect.

Some embodiments involve the injection of air at the trailing edge of a winglet to further reduce drag. This can be done through either passive or active designs. In the passive design, the leading edge of the winglet is made porous (e.g., holes machined, fabricated using mesh, etc.) to ingest air, and ducting placed within the wing carries that air to the trailing edge where it is injected. In the active design, air lines already within the wing are tapped, and openings would be created to facilitate trailing-edge air injection.

### BRIEF DESCRIPTION OF THE DRAWING

Embodiments of the present invention are illustrated by way of example, and not by way of limitation, in the figures of the accompanying drawings and in which like reference numerals refer to similar elements and in which:

FIG. 1 is a diagram illustrating a winglet with air outlets at the trailing edge, according to some embodiments.

FIG. 2 is a graph comparing raw drag, or co-efficient of drag relative to wind-axis (CDWA) of an unmodified winglet on a Boeing 737-800 aircraft, and corrected drag by use of trailing-edge injection outlets in an improved winglet, according to some embodiments.

### DETAILED DESCRIPTION OF EMBODIMENTS

In the following description, numerous specific details have been set forth to provide a more thorough understanding of embodiments of the present invention. It will be appreciated however, by one skilled in the art, that embodiments may be practiced without such specific details or with different implementations for such details. Additionally, some well-known structures have not been shown in detail to avoid unnecessarily obscuring the present embodiments.

Other and further features and advantages of the present embodiments will be apparent from the following descriptions of the various embodiments when read in conjunction with the accompanying drawings. It will be understood by one of ordinary skill in the art that the following embodiments and illustrations are provided for illustrative and exemplary purposes only, and that numerous combinations of the elements of the various embodiments of the present invention are possible. Further, certain block diagrams are not to scale and are provided to show structures in an illustrative manner. Exemplary systems and processes according to embodiments are described with reference to the accompanying figures. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

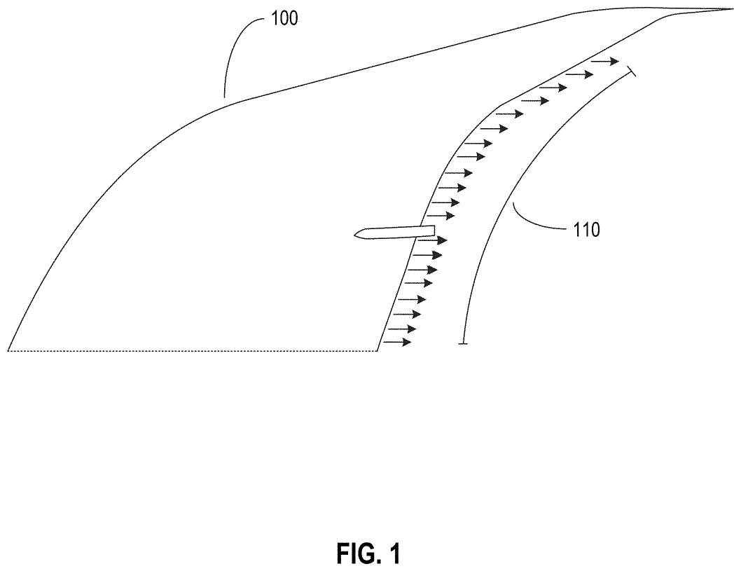

FIG. 1 is a top-view diagram illustrating a wing-tip 100 with a set of air outlets 110 at the trailing edge, according to some embodiments. In some embodiments, air outlets 110 are each a half-inch in diameter, although other sizes may be employed to optimize the effect for a particular wing without departing from the scope of the invention. In some embodiments, air outlets 110 are jet outlets. In some embodiments, placement of air outlets 110 occur at regular intervals along the trailing-edge of wing-tip 100, in the segment generally referred to as a winglet. According to some embodiments, air outlets 110 span ten feet along the trailing edge, and may extend from the winglet installation into the wing's basic area, although other spans of outlets may be employed to optimize the effect for a particular wing without departing from the scope of the invention. The span of air outlets 100 may extend to the ends of the wing-tip. Alternatively, a portion of the trailing edge to the tip may not include air outlets 110 if not feasible due to the structure of the wing tip.

According to some embodiments, air outlets 110 are passively supplied with air flow by leading edge air flow ingestion during flight, versus taking bleed air from one or more engines. For example, the leading edge of the wing, including wing-tip 100 may include one or more leading edge air or jet inlets, which then direct the air within the wing to one or more lower air outlets. In some embodiments, ducting between the leading-edge inlets and the trailing-edge outlets direct the flow of air through the wing. In some embodiments, in the passive design, the leading edge of the winglet is made porous (e.g., holes machined, fabricated using mesh, etc.) to ingest air, and ducting is placed within the wing carries that air to the trailing edge where it is injected. Different ducting designs can be used to control the degree of flow to particular outlets to maximize the reduction in vortex drag. By providing a passive wing tip blown effect, the desire would be to reduce vortex drag, and to provide additional lift. In addition, lower air outlets extending down from the winglet's trailing edge into the wing's basic area could also have an influence on reducing pressure-induced drag and friction drag.

According to some embodiments, air outlets 110 are actively supplied with air flow to provide trailing-edge injection effect at a plurality of outlets along the trailing edge of winglet 100. Such injected flow of air in the trailing edge direction may be sourced from engine bleed air lines in the wing (i.e., tied into anti-ice system). In the active design, air lines already within the wing are tapped, and air outlets 110 would be created to facilitate trailing-edge air injection. In some embodiments, such trailing-edge injection may be used in addition to the porous winglet which has leading edge flow ingestion and ducted flow in the trailing edge direction. In some embodiments, the winglet generates enough ducted lift to offset the winglet weight. Different ducting designs between the air source to the outlets can be used to control the degree of flow to particular outlets and to vary the airflow from one outlet to the next outlet, to maximize the reduction in vortex drag.

The addition of momentum by injection jets at the trailing edge near the winglet blend improves flow in this region, and could lead to reduced wing drag, thus reducing the full airplane drag. Drag changes could be moderated by inflow and outflow to provide the blowing momentum.

### EXAMPLES

A winglet with a winglet wing-tip having a trailing edge injection effect was evaluated with application of computational fluid dynamics (CFD). In this study, a CFD model of the B737-800 was used, having a generic winglet and blend. A typical cruise condition of M=0.8, 35,000 ft., AoA=2 was chosen. The source of the injectant was considered unknown, and the study focused on injection effects.

The wind tunnel flow conditions were as follows:

Mⱼₑₜ=0.80

Mass flow rate (mdot) of about 2 lbm/s per wing

Aⱼₑₜ total=0.10 sqft

Figures of test cases of embodiments show an apparent improvement in flow quality is demonstrated from trailing edge injection.

Testing showed that injection can produce changes both in lift and drag. However, trailing edge blowing disrupts the wing circulation and can cause a loss of lift.

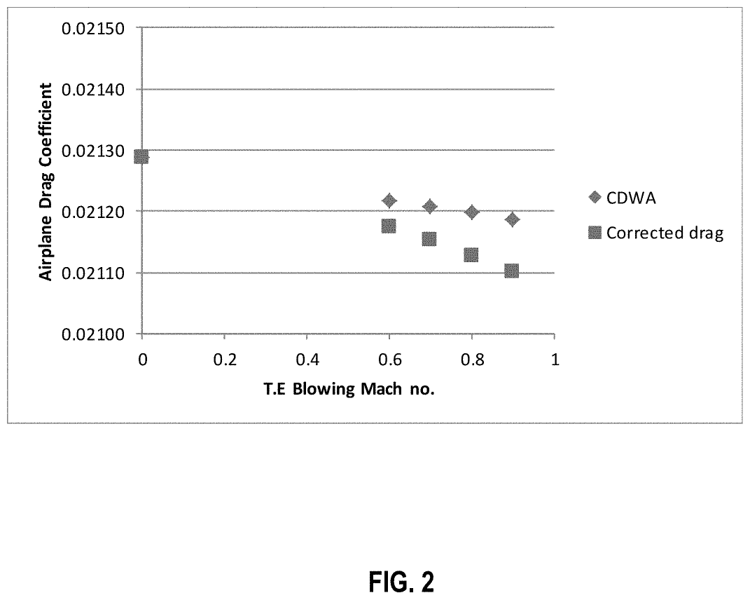

FIG. 2 is a graph comparing raw drag, or co-efficient of drag relative to wind-axis (CDWA) of an unmodified winglet on a Boeing 737-800 aircraft, and corrected drag by use of trailing-edge injection outlets in an improved winglet, according to some embodiments. The graph shows the parametric changes in airplane drag due to different trailing edge blowing rates M=0.6, M=0.7, M=0.8, M=0.9. Such blowing rates are in the range of possibility without active enhancement (e.g., pumping).

The study shows that the trailing-edge injection effect had a positive effect on fuel consumption. The addition of trailing-edge injection was shown to result in a representative 0.75% drag improvement with Mj=0.8. The total accepted drag improvement for winglets in general is 3.5% for conventional winglets. The B737-800 with various CFM engine variants uses about 2,630 lb/hr/engine. (Reference: www.aircraft-commerce.com) Assuming 5,260 lb/hr for the airplane, the savings are 0.75% of that, or about 40 lb/hr/plane. For a fleet of 100 short-haul planes flying on an average of 9 hours per day for 300 days a year, the addition of trailing-edge injection can result in savings are approximately 10.8 million lbs. of fuel per year. At estimated costs for fuel are around $2.40/gallon, and consumption of 6.8 lbs/gal, the trailing-edge injection savings for this example is 1.6 million gallons per year, resulting in top-line savings of approximately $3.8 M per year.

Based on the computational analysis, embodiments of the invention can be employed to reduce airplane drag from slightly less than one count, to a corrected airplane drag maximum reduction produced by trailing edge blowing in the range of two drag counts. Realistic factors can alter this apparent improvement, including jet thrust, injectant pressure losses, lift compensation, and inefficiencies in air handling, including inefficiencies in air handling at the leading edge and internal ducting that might reduce the trailing edge injection thrust. Such factors could reduce the realizable drag reduction to the range of one count.

Embodiments provide the benefits of:

Increased fuel efficiency: Modeling suggests embodiments of the invention will further reduce drag of winglet-equipped aircraft by 1-2 drag counts (i.e., 200-400 additional pounds of payload for the same fuel consumption). This could save a fleet of 100 Boeing 737-800 aircraft about $3.8 million in fuel costs every year. As one example, Southwest Airlines has a fleet of 750 planes, and thus could save ˜$28 million in annual fuel costs.

Straightforward implementation: Both the passive and active designs of embodiments of the invention are anticipated to be relatively simple for winglet and/or aircraft makers to implement for both new and existing aircraft.

Embodiments can be applied to essentially any aircraft (large or small) that currently uses winglets. The invention has been proven for the blended winglet type which accounts for perhaps 80% of winglets used, and can likely be optimized for alternate winglet types.

Other features, aspects and objects of the invention can be obtained from a review of the figures and the claims. It is to be understood that other embodiments of the invention can be developed and fall within the spirit and scope of the invention and claims.

The foregoing description of embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A wing for an aircraft, the wing comprising:
a wing-tip device extending from a distal end of a wing of an aircraft, a trailing edge section of the wing-tip device extending from a trailing edge of the wing;
a plurality of trailing edge openings formed in the trailing edge of at least the wing-tip device, the openings configured to inject air out of the trailing edge.

2. The wing for the aircraft of claim 1, wherein the plurality of trailing-edge openings comprise ends of ducts traversing through the wing from an air source.

3. The wing for the aircraft of claim 1, wherein the plurality of trailing edge openings are 0.5 inch in diameter.

4. The wing of the aircraft of claim 1, the wing comprising a plurality of leading edge inlets, the leading edge inlets directing air flow to the plurality of trailing-edge openings by one or more ducts traversing through the wing.

5. The wing of the aircraft of claim 2, the air source comprising air flow ingested through a plurality of leading edge inlets during flight, the leading edge inlets directing the air flow to the plurality of trailing-edge openings by one or more ducts traversing through the wing.

6. The wing of the aircraft of claim 2, the air source comprising air from bleed lines in the wing, the bleed lines receiving air from an engine.

7. The wing of the aircraft of claim 1, the plurality of trailing edge openings spanning the trailing edge for at least 10 feet from a distal opening to a proximal opening.

8. The wing of the aircraft of claim 1, the plurality of trailing edge openings spanning the trailing edge of the wing-tip device and the trailing edge of the wing.

9. The wing of the aircraft of claim 2, the ducts configured to vary the airflow among the plurality of trailing edge outlets.
